(19) United States
(12) Patent Application Publication
(10) Pub. No.: US 2017/0373536 A1
(43) Pub. Date: Dec. 28, 2017

(54) Smart Remote Power Management Method and Apparatus

(71) Applicant: Powermatic Technologies bvba, Leuven (BE)

(72) Inventor: Hazim Makki Al Hajjaj, Leuven (BE)

(21) Appl. No.: 15/630,724

(22) Filed: Jun. 22, 2017

Related U.S. Application Data
(60) Provisional application No. 62/354,061, filed on Jun. 23, 2016.

(51) Int. Cl. H02J 13/00; G05B 19/042; H04L 29/08

(52) U.S. Cl. CPC H02J 13/0075; G05B 19/042; H04L 67/12; G05B 2219/2642

(57) ABSTRACT

Embodiments disclosed herein include a power management apparatus including a smart circuit breaker (“iCB”) that wirelessly communicates with one or multiple power consuming devices. The iCB also communicates with a power provider (power company) to manage preset power quotas for consumers. Aspects include management of device priorities such that devices with higher priorities receive power before those with lower priorities when quotas are exceeded for a consumer premises.

### RELATED APPLICATIONS

This application claims priority from U.S. Provisional Patent Application No. 62/354,061 filed Jun. 23, 2016, which is incorporated by reference in its entirety herein.

### BACKGROUND

Electricity plays an important part in our everyday lives. Availability of a dependable supply of electricity is an increasingly urgent issue for both developing and developed countries. In developing countries more than two billion people still have extremely limited access to electric power; users fulfill their basic needs by using a low-quality supply available for few hours per day. At the same time, highly industrialised countries are facing a significant energy availability challenge. It is estimated that energy demand for air conditioning by the year of 2100 will be 40 times greater than it was in 2000, and alongside this, there is also an ever-increasing market for electric vehicles. Countries, individuals and companies are becoming ever more dependent upon electrical power, yet supply will struggle to meet demand especially considering the current rate of population growth and the continuous sophistication and prevalence of electrical appliances in homes, work places and social environments. Accordingly, a major problem affecting the current electric energy supply system is power outages/interruptions that are scheduled or unscheduled. Both developing and developed countries increasingly experience power interruption, for example because of: lack of investments in power grid improvements; and increase of demand due to transformation of living habits.

In reaction to this reality, in some countries/regions authorities install low-amp circuit breakers at the main distribution board of the consumer premises to limit the consumption so that the providers of electrical services can serve more consumers at a time. Still, it has not been possible for providers to provide power without interruption. Significant causes for this failure include the fact that the low-amp (10 A for example) power capacity for each customer adds up to more than the power available for distribution, or the power low-amp capacity available to consumers is lower than their demand. Another cause includes attempts of some customers to override circuit breakers and consume more power than the available quota, which makes the distribution in a quota, and limiting power capacity for each customer unachievable.

There is currently no low cost, easily deployable solution to relieve the above problems.

### BRIEF DESCRIPTION OF THE DRAWINGS

FIG. 1 is a diagram of a smart circuit breaker (iCB) system) according to an embodiment.

FIG. 2 is a diagram of a smart load (iLoad) system with an iCB unit according to an embodiment.

FIG. 3 is a diagram of an iCB system including home and office and a 3-phase iCB unit according to an embodiment.

FIG. 4 is a diagram of a single phase iCB unit according to an embodiment.

FIG. 5 is a diagram of a 3-phase iCB unit according to an embodiment.

FIG. 6 is a circuit diagram for an iCB unit according to an embodiment.

FIG. 7 is a circuit diagram of a remotely controlled variable tripping circuit according to an embodiment.

FIG. 8 is a flow diagram of an iCB unit process flow according to an embodiment.

FIG. 9 is a flow diagram of an iLoad system process according to an embodiment.

FIG. 10 is a diagram illustrating a communication flow between a Utility (energy provider) and an iCB unit according to an embodiment.

### DETAILED DESCRIPTION

Described and claimed herein are methods and apparatus for monitoring available electrical power supply at a customer premises (e.g., residence, company, factory). In an embodiment, a device is a controller that remotely limits the power supplied according the quote available to be supplied. Whenever there are customers who consume power less than the quota, which mean there will be excess of power that can be utilized, the power distribution center can increase the quota for each customer, and so on till the power generated is fully consumed. If the consumers who were not using the power as per the quota, and that the generated power become less than allowed to be consumed as per quota, the distribution company can decrease the quota so that the consumption will be less and make the distribution grid balanced and not subject to scheduled power interruption.

In an embodiment, a variable rating circuit breaker, or smart circuit breaker (referred to herein as “iCB”) performs similarly to a conventional circuit breaker. However, a variable rating will be decided by the power supplier according to the power capacity available to be supplied. Customers (also referred to as consumers herein) can manage their consumption within the given quota. In the situation in which a customers' power usage exceeds the stated quota, the iCB will give an audible buzzer/LED indication, giving the customer time to manage the load at the customer premises.

In an embodiment, whenever there are customers who consume power less than the quota, which mean there will be an excess of power that can be utilized, the power distribution center can increase the quota for each customer, and so on till the power generated is fully consumed. If there are consumers who are not using the power as per their quota, such that the generated power become less than allowed to be consumed as per quota, the distribution company can decrease the quota for the so that the consumption will be less and make the distribution grid balanced and not subject to scheduled power interruptions.

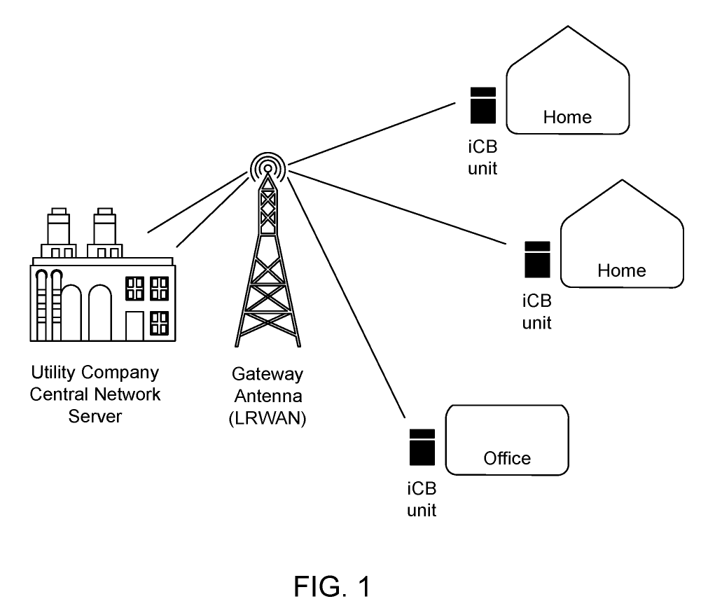

FIG. 1 is a diagram of a smart circuit breaker (iCB) system) according to an embodiment. iCB units can reside at multiple locations as shown. In the figure iCB units reside at two different homes and one office. iCB units communicate wirelessly with a gateway antenna which also communicates with a power supplier (utility company central network server).

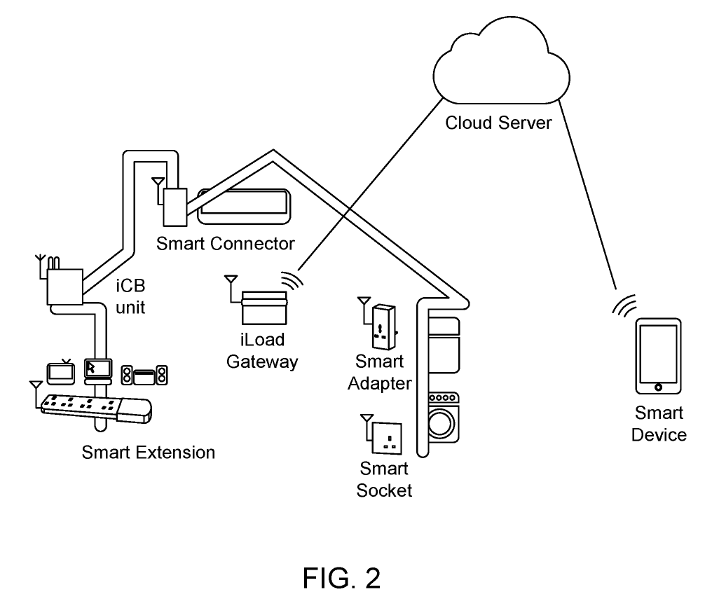

FIG. 2 is a diagram of a smart load (iLoad) system with an iCB unit according to an embodiment. iLoad is a software application that facilitates a home area network. The iLoad system includes an iLoad gateway and a smart device (such as a smart phone) that communicate wirelessly via any conventional cloud server. Within the home are also an iCB unit, a smart connector, a smart adapter, and a smart socket. A smart extension, in an embodiment, is a remote controller to control the iLoad system In an embodiment, the iLoad system receives the value of the maximum quota allowed for the premises from the power supplier and manages different loads based on priorities set by the user, in order to prevent exceeding quotas.

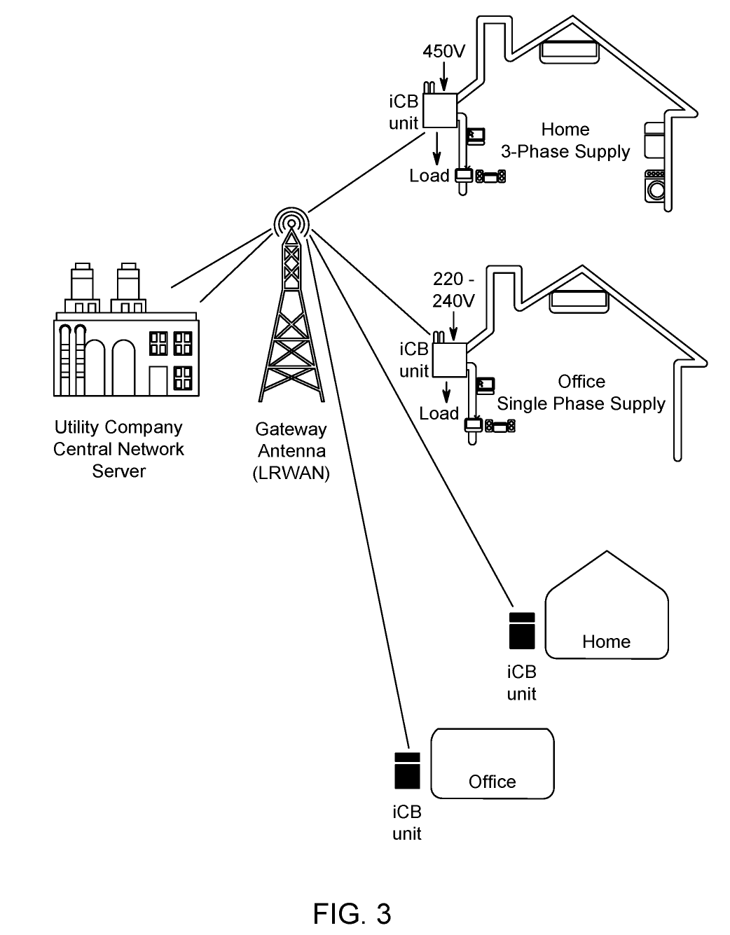

FIG. 3 is a diagram of an iCB system including home and office and a 3-phase iCB unit according to an embodiment. The iCB system includes iCB units in both a home and an office. In an embodiment, the home iCB is a 3-phase iCB unit (as further described below) and the office iCB unit is a single-phase iCB unit (as further described below). As shown, the 3-phase iCB receives 450 volts, while the single phase iCB receives 220-240 volts. The iCB units communicate wirelessly with a conventional wireless gateway antenna (LRWAN) and via that antenna, with a utility company network server.

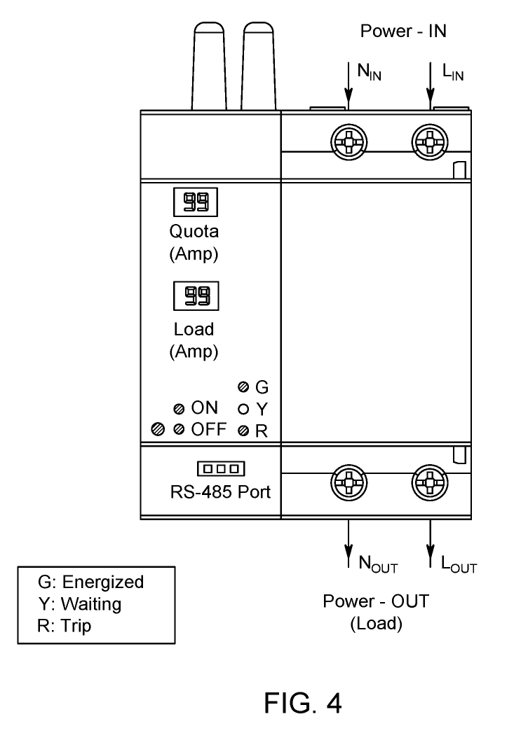

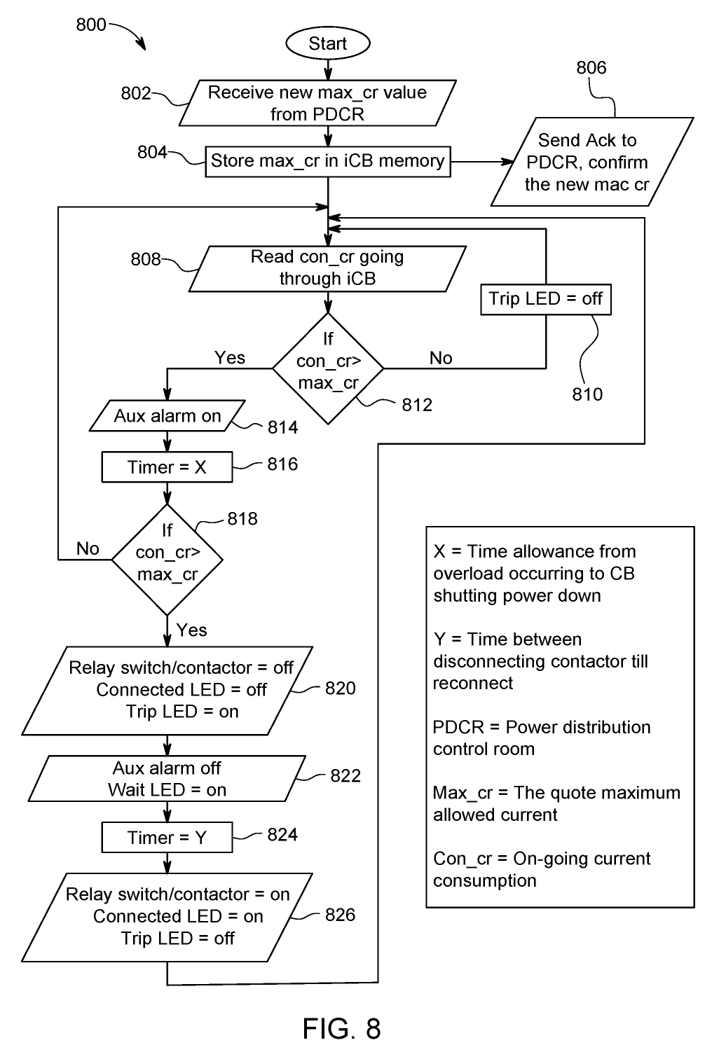

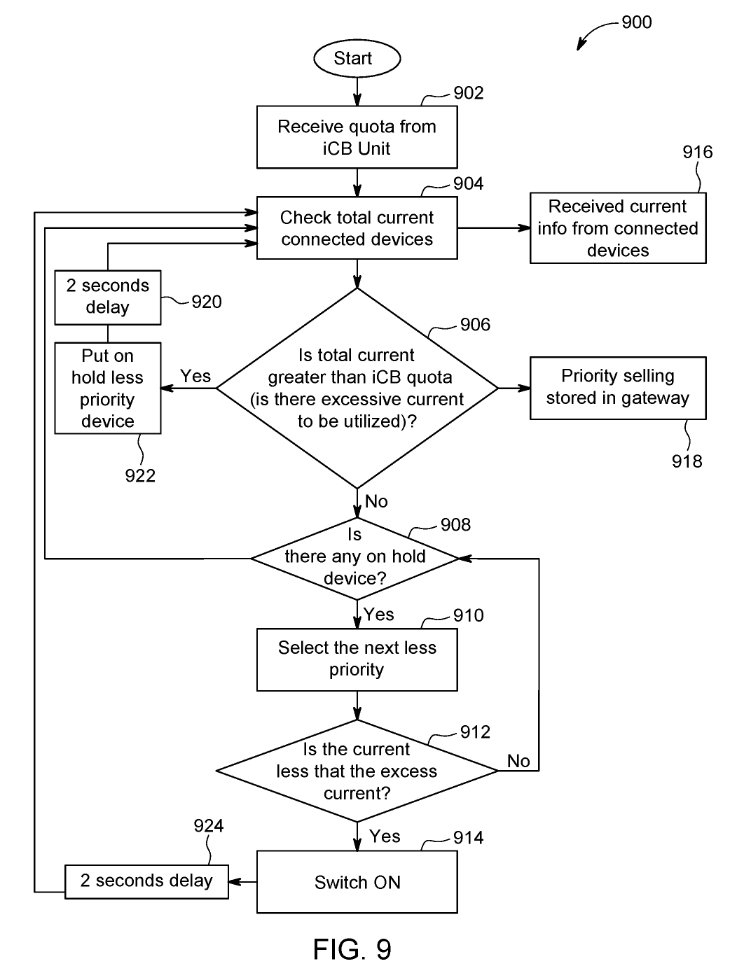

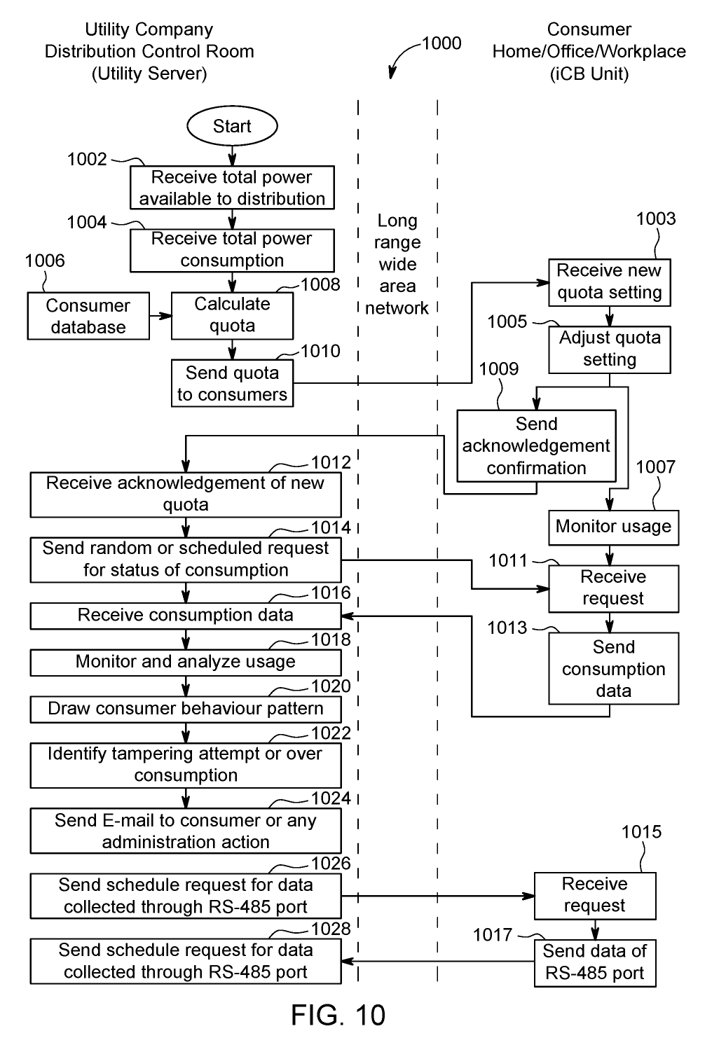

FIG. 4 is a diagram of a single phase iCB unit according to an embodiment. The single phase iCB unit includes coupling points for power in and power out. The single phase iCB unit further includes a display for showing the quota (in amperes) available, and a display for showing the actual load (in amperes). In addition, lights on the single phase iCB unit (e.g., LED lights) illustrate states of the power supply of the premises, including “energized”, “waiting”, and “trip”. “Energized indicates that a device is receiving power. “Waiting” indicates that the iLoad system is assessing whether the device should receive power, and “tripped” indicates that the circuit breaker has tripped, shutting off power to the device after determining that the device should not re4cieve power at the present time (the method is further described with reference to FIG. 8, FIG. 9, and FIG. 10).

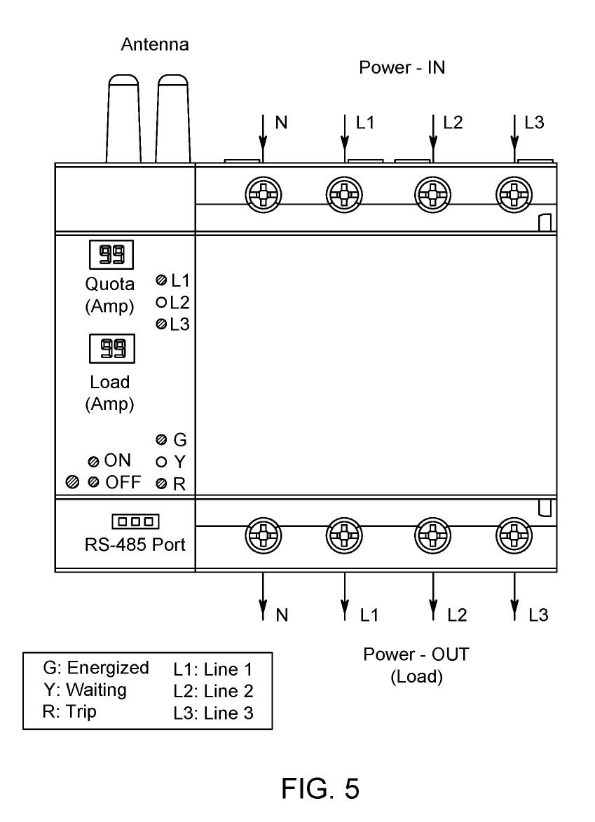

FIG. 5 is a diagram of a 3-phase iCB unit according to an embodiment. The 3 phase iCB unit includes coupling points for power in and power out. The 3-phase iCB unit has three input ports (L1, L2, and L3) as compared the single phase iCB unit. The 3-phase iCB unit further includes a display for showing the quota (in amperes) available, and a display for showing the actual load (in amperes). In addition, lights on the single phase iCB unit (e.g., LED lights) illustrate states of the power supply of the premises, including “energized”, “waiting”, and “trip”. Lights indicate which line (L1, L2, or L3) is being monitored.

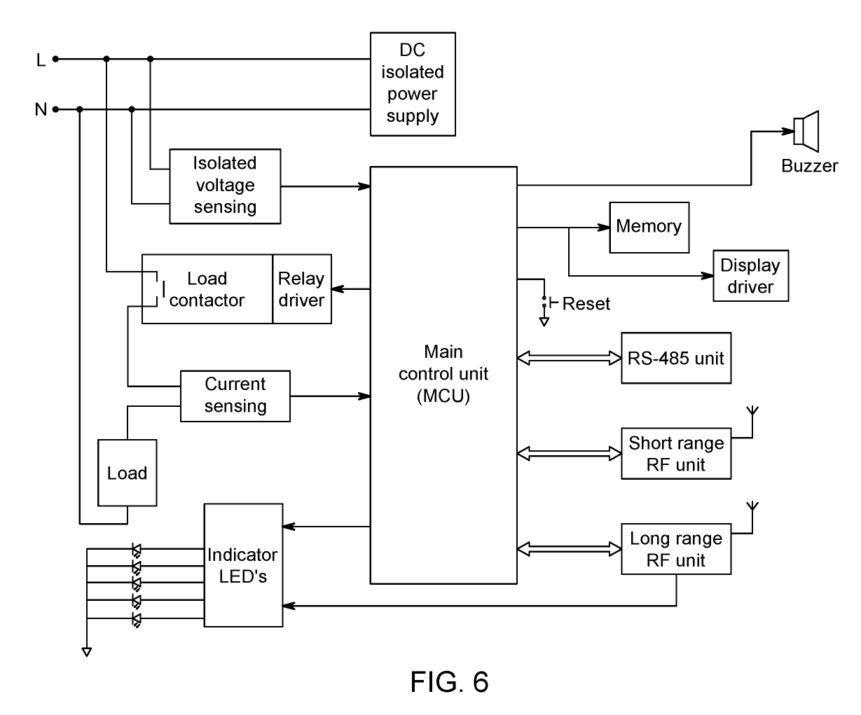

FIG. 6 is a circuit diagram for an iCB unit according to an embodiment. The iCB unit includes main control unit (MCU) which in most embodiments, is an integrated circuit including one or more processors designed and/or programmed to operate according to the methods disclosed herein. A direct current (DC) power isolated supply provides power the iCB unit. An isolated voltage sensing unit is coupled to the power supply and provides input to the MCU. Also coupled to the power supply are a load contactor and a load unit. The load contactor receives feedback from the MCU and outputs information to a current sensing unit. The current sensing unit also receives input from the load unit and outputs load information to the MCU.

The MCU is further coupled to a buzzer for audibly notifying the user/customer of power supply situations. Also coupled the MCU are a memory unit, a display driver, an RS-485 unit (for managing the RS-485 port. The memory unit in some embodiments stores software instructions for executing the methods described herein. Also included for wireless communications are a short range radio frequency (RF) unit and a long range RF unit.

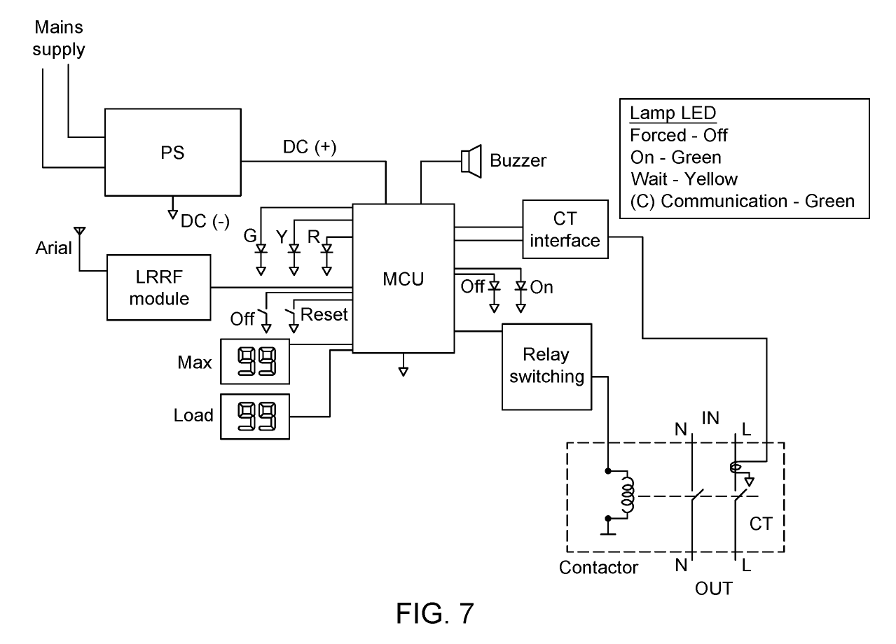

FIG. 7 is a circuit diagram of a remotely controlled variable tripping circuit according to an embodiment. The circuit diagram of FIG. 7 is an alternative representation of the iCB unit and MCU of FIG. 6. This representation shows further circuit detail and also illustrates the LED displays.

FIG. 8 is a flow diagram of an iCB unit process flow 800 according to an embodiment. Refer to the legend in the figure for an explanation of the abbreviations.

At 802, the MCU receives a new max_cr value from PDCR This maximum value is stored in iCB memory at 804. An acknowledgement is sent to PDCR at 806. The ongoing power consumption (con_cr) going through the iCB is read by the iCB at 808. At 812, it determined whether the ongoing current consumption (Con_cr) is greater than the quote maximum allowed current (Max_cr). If (Con_cr) is not greater than (Max_cr), the LED indicating exceeding Max_cr is off (or turned off, it was previously On).

If (Con_cr) is greater than (Max_cr), an Aux alarm is activated at 814. Then a timer is set at 816. The inquiry of 812 is repeated, and if the response is “no” the process returns to 808 If the response is “yes”, then at 820, a relay switch/contactor is turned off, a connected LED is turned off, and the trip LED is turned on.

At 822, the aux alarm is off, and the “wait” LED is turned on. A timer is enabled at 824. At 826, after the expiration of the timer, the relay switch/contactor is turned on, the connected LED is turned on and the trip LED is turned off, Then the process returns to 808.

FIG. 9 is a flow diagram of an iLoad system process 900 according to an embodiment. Reference can also be made to FIG. 2 At 902, a predetermined quota for power usage is received from the iCB unit. The predetermined quota can be programmed, for example by using a wirelessly connected smart device. The total current of all connected devise is checked at 904, resulting data that represents the received current from connected devices at 916.

At 906, it is determined whether the total current is greater than the iCB quota (and whether there is excess current available to be utilized). If the total current is greater than the iCB quota, devices that have lower priority are put on hold at 922. Devices can be assigned a priority by programming the iCB unit, for example by using the smart device. After a predetermined delay time 920 (for example two seconds), the total current of connected devices is checked again at 904.

If the total current is not greater than the iCB quota 906, it is determined whether there are any “on hold” devices at 908. If there are on hold devices, the device with the next less priority is selected at 910. If the current of the selected device is less than the excess current (912), the selected device is switched on. Once the selected device is turned on, a predetermined delay time passes (for example two seconds as shown at 924), and the total current of connected devices is checked at 904.

If the current of the selected device is not less than the excess current (912), the process returns to 908.

FIG. 10 is a diagram illustrating a communication flow between a utility company (for example the utility company's distribution server) and an iCB unit according to an embodiment.

Reference can also be made to FIG. 3. On the left hand side of the diagram, the utility company server receives data representing the total power available for distribution at 1002, as well as the total power consumption at 1004. The utility company server (“the server”) then calculates a power quota at 1008 using consumer database information as an input (1006). The quota data for each consumer is sent to consumers at 1010. The new quota includes a new quota setting that is sent to a consumer's iCB unit at the consumer premises at 1003. The new quota setting can be sent via any know communication method. A long range wide area network is shown as an example, but is not intended to be limiting The iCB unit adjusts the quota setting at 1005 based on the received new quota setting, and begins to monitor power usage (1007) for all of the devices at the premises.

The iCB unit sends an acknowledgement of the receipt of the new quota setting at 1009 The acknowledgement is received by the server at 1013. Thereafter, the server sends random or scheduled requests for the status of consumption to the iCB unit at 1015. When the iCB unit receives the request at 1011, the iCB unit sends consumption data to the server at 1013. When the server receives the consumption data (1016), the server monitors and analyzes usage (1018. From the monitoring an analyses, a consumer behavior pattern is drawn (1020). This allows the server to identify tampering attempts or over-consumption (1022). If any administration action is required, an email is sent to the consumer (1024).

In an embodiment, regularly scheduled requests for data collected through the iCB unit RS-485 port (see for example, FIGS. 4 and 5) are sent by the server and received by the iCB unit (1026 and 1015). The data is sent by the iCB unit and received by the server (1017 and 1028).

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

1. A system for smart remote power management, comprising:
at least one smart circuit breaker (“iCB”) communicatively coupled to a gateway antenna for the purpose of communicating with a power utility company network server (“utility server”), wherein the iCB comprises,
a main control unit (“MCU”);
a current sensing unit;
a memory unit; and
a display device;
at least one device coupled to the at least one iCB such that the at least one iCB can monitor power requirements of the at least one device and control power supplied to the at least one device; and
wherein the memory stores instructions for a method that is executed by the MCU, the method comprising,
the at least one iCB unit communicating wirelessly with the utility server, to send power consumption data to the utility server; and
receive instructions from the utility server regarding how to control the at least one device

2. The system of claim 1, wherein the at least one iCB unit further receives data from the utility server that represents a power quota for the at least one device.

3. The system of claim 1, wherein the display device provides a visual indication of one or more of the following:
an actual power load in amperes; and
states of power supply to the at least one device

4. The system of claim 3, wherein the display device further providers a visual indication of one or more of the following:
an “energized” state indicating that the at least one device is currently being powered;
a “waiting” state indicating that the iCB is waiting for instructions from the utility server; and
a “trip” state indicating that the at least one device has been denied power based on data received by the iCB from the utility server

5. The system of claim 4, wherein the method further comprises:
receiving a new maximum power quota from the utility server;
reading on-going current consumption of the at least one device; and
if the on-going current consumption exceeds the maximum power quota, turning an alarm on, wherein the alarm may be audio or visual.

6. The system of claim 5, wherein the method further comprises:
starting a timer to wait for a next determination of whether the on-going current consumption exceeds the maximum power quota; and
if the on-going current consumption does not exceed the maximum power quota, visually indicating that the trip state is “off”; and
reading on-going current consumption again.

7. The system of claim 5, wherein the method further comprises:
if the on-going current consumption exceeds the maximum power quota;
starting a timer to wait for a next determination of whether the on-going current consumption exceeds the maximum power quota; and
if the on-going current consumption does exceed the maximum power quota,
cutting off power from the at least one device;
visually indicating that the trip state is “on”; and
visually indicating that the at least one device is “not connected”.

8. The system of claim 7, wherein the method further comprises:
starting a timer and visually indicating a “wait state”.

9. The system of claim 8, wherein the method further comprises:
after the timer expires, restoring power to the at least one device;
visually indicating that the at least one device is “connected”;
visually indicating that the trip state is “off”; and
determining again whether the on-going current consumption does exceed the maximum power quota.

10. A method for remote power management, comprising:
a processor receiving a predetermined power usage quota (“quota”) that indicates an amount of power that one or more devices may use within a time period;
the processor receiving data comprising a total electrical current usage of the one or more devices at the present time; and
the processor determining whether the total electrical usage is greater than a predetermined quota.

11. The method of claim 10, wherein one or more devices reside at one or more physical locations and are associated with a single power consumer, wherein the single power consumer comprises one or more of an individual household and a corporation.

12. The method of claim 10, further comprising;
setting a priority for each of the one or more devices, wherein a priority for a device indicates its importance for receiving power over other devices; and
if the total electrical usage is greater than a predetermined quota, the one or more devices, putting lesser priority devices on an “on hold” status.

13. The method of claim 12, further comprising:
starting a predetermined delay, after the expiration of which, the processor again receives data comprising a total electrical current usage of the one or more devices at the present time.

14. The method of claim 12, further comprising:
if the total electrical usage is not greater than a predetermined quota, the processor determining whether any of the devices is in a “hold” state.

15. The method of claim 14, further comprising, if any of the devices is in a “hold” state, selecting a device with a next less priority.

16. A method for managing power usage at consumer premises involving a power supplier (“utility company”), the method comprising:
the utility company receiving a total amount of power available for distribution;
the utility company calculating a total amount of power available for consumption;
the utility company calculating a quota of available power based on the power available for distribution, the power available for consumption, and consumer information in a consumer database; and
the utility company sending quotas to consumers.

17. The method of claim 16, further comprising:
a consumer receiving the quota intended for it;
the consumer adjusting its quota setting using a smart circuit breaker (“iCB”); and
the iCB monitoring power usage and communicating power usage data to the utility company

18. The method of claim 17 claim further comprising:
the utility company receiving the power usage data; and
using the power usage data to monitor and analyze power usage of the consumer;

19. The method of claim 18 further comprising the utility company using the power usage data to construct a consumer behavior pattern.

20. The method of claim 19 further comprising the utility company using the power usage data to communicate to the consumer any administrative action, wherein an administrative action includes one or more of:
a device at the consumer premises exceeding an allocated power amount for its previously assigned priority relative to other devices at the consumer premises;
perceived tampering with data communications; and
a request for data from the consumer.
